(19) United States
(12) Patent Application Publication
(10) Pub. No.: US 2015/0263836 A1
(43) Pub. Date: Sep. 17, 2015

(54) METHOD OF MOBILITY MANAGEMENT FOR MOBILE TERMINAL IN A HETEROGENEOUS NETWORK ENVIRONMENT

(71) Applicant: Electronics and Telecommunications Research Institute, Daejeon (KR)

(72) Inventor: Jae Heung KIM, Daejeon (KR)

(21) Appl. No.: 14/728,171

(22) Filed: Jun. 2, 2015

Related U.S. Application Data
(63) Continuation of application No. 13/547,489, filed on Jul. 12, 2012.

(30) Foreign Application Priority Data
Jul. 12, 2011 (KR) 10-2011-0068834
Sep. 15, 2011 (KR) 10-2011-0093083
Sep. 30, 2011 (KR) 10-2011-0099545
Jan. 31, 2012 (KR) 10-2012-0009482

(51) Int. Cl. H04L 5/00; H04W 72/04; H04W 76/02

(52) U.S. Cl. CPC H04L 5/0035; H04W 76/025; H04W 72/042; H04W 72/048

(57) ABSTRACT

A method for managing mobility of a terminal in a heterogeneous network environment is provided. According to an aspect, there is provided an operation method of a terminal receiving parameters for Coordinated Multi-point transmission/reception (CoMP) operation in a heterogeneous network environment, the operation method including, at the terminal, receiving at least one parameter among a CoMP operation mode parameter, a time information parameter regarding a time at which the CoMP operation starts, a point information parameter about points that participate in the CoMP operation, and a CoMP operation parameter, from a base station, through a layer-3 message. Therefore, it is possible to avoid an unnecessary ping-pong handover and efficiently provide service continuity.

### CLAIM FOR PRIORITY

This application is a continuation of U.S. patent application Ser. No. 13/547,489, filed on Jul. 12, 2012, which claims priority to Korean Patent Application No. 10-2011-0068834 filed on Jul. 12, 2011, Korean Patent Application No. 10-2011-0093083 filed on Sep. 15, 2011, Korean Patent Application No. 10-2011-0099545 filed on Sep. 30, 2011, and Korean Patent Application No. 10-2012-0009482 filed on Jan. 31, 2012, in the Korean Intellectual Property Office (KIPO), the entire contents of which are hereby incorporated by reference.

### BACKGROUND

1. Technical Field

An example embodiment of the present invention relates in general to a mobile communication system, and more specifically, to a method for managing mobility of mobile terminals in a heterogeneous network environment where a plurality of transmission and reception points placed in different geopolitical locations have to support a Coordinated Multi-point transmission/reception (CoMP) function to provide services.

2. Related Art

A packet based cellular system using a conventional mobility management method has difficulties in supporting a method such as Coordinated Multi-point transmission/reception (CoMP) of improving service performance and maintaining service continuity through coordination of a plurality of base stations placed at different geopolitical locations, although it supports Carrier Aggregation (CA) of providing services through a plurality of serving carriers.

Mobility management that has been generally used in a packet based cellular mobile communication system is based on a handover procedure in which a terminal establishes, when it moves from a source base station from which the terminal has received service to another base station (that is, a target base station) from which the terminal will receive new service, a connection with respect to a control channel through information exchange with the target base station, then the terminal accesses the target base station to establish a connection with respect to a data channel, and thereafter the terminal is disconnected from the source base station, in order to maintain continuity of a Radio Bearer (RB) connection established between the source base station and the terminal. Particularly, in an environment such as a heterogeneous network where macro layer base stations coexist with micro layer base stations, a ping-pong handover often occurs between terminals and base stations, which increases system load and causes Radio Link Failure (RLF) due to performance deterioration of radio channel quality, caused by interference appearing in cell edges, resulting in performance deterioration of the entire system.

Also, the conventional mobility management uses a handover algorithm of simply changing a base station without considering CoMP.

### SUMMARY

Accordingly, example embodiments of the present invention are provided to substantially obviate one or more problems due to limitations and disadvantages of the related art.

An example embodiment of the present invention provides a method in which a terminal operates in a heterogeneous network environment, the method including a method in which the terminal receives Coordinated Multi-point transmission/reception (CoMP)-related parameters from a base station, wherein the CoMP-related parameters are defined to perform CoMP operation and be shared between the terminal and the base station in the heterogeneous network environment.

Another example embodiment of the present invention also provides a method in which a terminal and a base station, specifically a terminal, processes, when it performs measurement needed to perform CoMP operation in a heterogeneous network environment, modification and termination of the measurement.

Another example embodiment of the present invention also provides a method in which a terminal and a base station operate to start or terminate CoMP operation in a heterogeneous network environment.

Another example embodiment of the present invention also provides a method of managing mobility of a terminal in consideration of interference between cells in a heterogeneous network environment, and more specifically, a method in which a terminal performs a handover between base stations in consideration of interference between cells.

In an example embodiment, there is provided an operation method of a terminal receiving parameters for Coordinated Multi-point transmission/reception (CoMP) operation in a heterogeneous network environment, including, at the terminal, receiving at least one parameter among CoMP operation mode parameters, a time information parameter regarding a time at which the CoMP operation starts, a point information parameter about points that participate in the CoMP operation, and a CoMP operation parameter, from a base station, through a layer-3 message.

The CoMP operation mode parameters may include a parameter indicating at least one operation mode of a Joint Processing (JP) mode, a Dynamic Cell Selection (DCS)/Dynamic Point Selection (DPS) mode, and a Coordinated Scheduling (CS)/Coordinated Beamforming (CB) mode, or a parameter indicating a combination of at least two operation modes of the JP mode, the DCS/DPS mode, and the CS/CB mode.

The CoMP operation mode parameters may include CoMP operation link setting information, and the CoMP operation link setting information may indicate that the CoMP operation is dedicated to downlink or uplink, that the CoMP operation is able to be applied to both downlink and uplink, or that the CoMP operation is performed through decoupling of downlink and uplink.

The time information parameter regarding the time at which the CoMP operation starts may be configured to include a value designating at least one of a reference radio frame, a reference radio subframe, and a reference radio slot at which the CoMP operation starts, and an offset value from a point at which the reference radio frame, the reference radio subframe, and the reference radio slot start.

The point information parameter about the points that participate in the CoMP operation may include at least one parameter of an identifier parameter for indentifying each point that participates in the CoMP operation, an identifier parameter of a point that primarily performs the CoMP operation, an identifier parameter for identifying the corresponding CoMP operation, and a parameter regarding a reference signal of each point that participates in the CoMP operation.

The parameter indicating the at least one operation mode of the JP mode, the DCS/DPS mode, and the CS/CB mode may include at least one piece of information among radio resource allocation information for supporting CoMP by a plurality of nodes, feedback parameter setting information, frequency band deployment information for avoiding interference, related Precoding Matrix Indicator (PMI) information, beam-related information, and information about a cell/node that primarily performs CoMP, wherein the feedback parameter includes PMI setting information, Channel Status Indication (CSI) setting information, and Rank Indication (RI) setting information.

The parameters for the CoMP operation may include a threshold value or a reference value of the quality of a reception signal for entering/starting/releasing the CoMP operation.

In another example embodiment, there is provided an operation method of a terminal performing measurement for Coordinated Multi-point transmission/reception (CoMP) operation, including: receiving a periodic measurement report or an aperiodic measurement report from a base station; receiving a message for changing or stopping the periodic measurement report or the aperidic measurement report from the base station; and changing or stopping the periodic measurement report or the aperiodic measurement report in response to the message.

The operation method may further include, at the terminal, transmitting a request message for changing or stopping the periodic measurement report or the aperiodic measurement report to the base station.

In another example embodiment, there is provided an operation method of a terminal entering or releasing Coordinated Multi-point transmission/reception (CoMP) operation, including: receiving parameter information related to a threshold value or a reference value for at least one of a reception signal, a timer, and an event for deciding whether to perform CoMP operation, from a base station; reporting the results of measurement on a reception signal based on the parameter information, to the base station; and receiving a CoMP operation start instruction including information about whether to perform CoMP operation and a CoMP operation mode, decided based on the results of the measurement, from the base station, or receiving a CoMP operation release instruction decided based on the results of the measurement, from the base station.

The information about whether to perform the CoMP operation and the CoMP operation mode may be decided based on at least one among the results of the measurement, information about a radio channel measured by the base station, a load state of the base station, available transmission power of the base station, and influence of interference of the base station. The terminal may measure the influence of the interference using an Almost Blank Subframe (ABS) pattern that is applied to the base station, and a macro layer base station, a micro layer base station, and a plurality of remote wireless nodes neighboring the base station, and report the results of the measurement to the base station.

In another example embodiment, there is provided an operation method of a base station deciding to enter or release Coordinated Multi-point transmission/reception (CoMP) operation, including: transmitting parameter information related to a threshold value or a reference value for at least one of a reception signal, a timer, and an event for deciding whether to perform CoMP operation, to a terminal; receiving the results of measurement on a reception signal based on the parameter information, from the terminal; and determining whether to perform CoMP operation and deciding a CoMP operation mode, based on at least one among the results of the measurement, information about a radio channel measured by the base station, a load state of the base station, available transmission power of the base station, and influence of interference of the base station, and transmitting a CoMP operation start instruction including information about whether to perform CoMP operation and a CoMP operation mode, to the terminal, or transmitting a CoMP operation release instruction to the terminal.

The base station may control the terminal to perform measurement and report using an Almost Blank Subframe (ABS) pattern that is applied to the base station, and a macro layer base station, a micro layer base station, and a plurality of remote wireless nodes neighboring the base station in order to estimate the influence of the interference.

In another example embodiment, there is provided an operation method of a terminal performing a handover procedure in a heterogeneous network environment, including: receiving information about a measurement period for measuring a neighboring base station, from a base station; measuring an Almost Blank Subframe (ABS) frame and a non-ABS frame of the neighboring base station in the measurement period after distinguishing the ABS frame from the non-ABS frame, and transmitting the results of the measurement to the base station; and receiving a handover execution instruction from the base station based on the results of the measurement, and performing a handover according to the handover execution instruction.

The operation method may further include, at the terminal, receiving identifier information of the neighboring base station and ABS pattern information from the base station.

In another example embodiment, there is provided an operation method of a base station performing a handover in a heterogeneous network environment, including: transmitting information about a measurement period for measuring a neighboring base station, to a terminal; receiving the results of measurement on an Almost Blank Subframe (ABS) frame and a non-ABS frame of the neighboring base station in the measurement period after distinguishing the ABS frame from the non-ABS frame, from the terminal; and deciding a target base station to which the terminal is to be handed over, based on the results of the measurement, and transmitting a handover execution instruction for a handover to the target base station to the terminal.

The operation method may further include, at the base station, transmitting identifier information of the neighboring base station and ABS pattern information to the terminal.

The base station may compare a measured value on the ABS frame of the neighboring base station, a measured value on the non-ABS frame of the neighboring base station, the threshold values for the each measured values and a difference value between the measured values to a reference value, based on the results of the measurements, and decide the target base station based on the results of the comparison.

Therefore, when a plurality of base stations or nodes placed at different geopolitical locations support CoMP to provide services in a heterogeneous network environment of a packet-based mobile communication system, it is possible to prevent interference between the base stations or nodes and improve the performance of the system.

For this, by proposing a method of managing mobility of terminals in consideration of CoMP operation of receiving services from a plurality of base stations or a plurality of remote wireless node(s), it is possible to avoid an unnecessary ping-pong handover and efficiently provide service continuity.

### BRIEF DESCRIPTION OF DRAWINGS

Example embodiments of the present invention will become more apparent by describing in detail example embodiments of the present invention with reference to the accompanying drawings, in which:

FIG. 1 is a view for explaining the concept of an intra-evolved Node B (intra-eNB) environment among heterogeneous network environments;

FIG. 2 is a view for explaining the concept of an inter-evolved Node B (inter-eNB) environment among heterogeneous network environments;

FIG. 3 is a flowchart illustrating a method of managing measurement for mobility management in a heterogeneous network environment, according to an embodiment of the present invention;

FIG. 4 is a view for explaining a method in which a plurality of base stations or a plurality of transmission nodes support a Coordinated Multi-point transmission/reception (CoMP) function and perform mobility management in a heterogeneous network environment, according to an embodiment of the present invention;

FIG. 5 is a flowchart illustrating a method of managing mobility in consideration of start of CoMP operation in a heterogeneous network environment, according to an embodiment of the present invention;

FIG. 6 is a flowchart illustrating a method of managing mobility in consideration of release of CoMP operation in a heterogeneous network environment, according to an embodiment of the present invention;

FIG. 7 is a view for explaining the concept of mobility management in consideration of interference between cells in a heterogeneous network environment, according to an embodiment of the present invention;

FIG. 8 is a flowchart illustrating a method of managing mobility in consideration of interference between cells in a heterogeneous network environment, according to an embodiment of the present invention; and

FIG. 9 is a conceptual view for explaining an example where an ABS pattern is applied and a measurement period is set in a heterogeneous network environment, according to an embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as a Mobile Station (MS), User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, the term “base station” used in this specification means a fixed or movable node that generally communicates with terminals, and may be referred to as another word, such as Node-B, eNode-B, a basetransceiver system (BTS), an access point, a relay, a femto-cell, etc.

In the following Coordinated Multi-point transmission/reception (CoMP)-related description, the term “node” or “point” means one of a base station (a macro layer base station or a micro layer base station), eNB, a cell, a femto cell/femto base station, a home cell/Home eNB, a Remote Radio Head (RRH), a relay, etc. in a mobile communication system. Also, each node or point means a transmission node or a transmission point in view of downlink (terminal's reception), and means a reception node or a reception point in view of uplink (terminal's transmission).

Hereinafter, embodiments of the present invention will be described in detail with reference to the appended drawings. In the following description, for easy understanding, like numbers refer to like elements throughout the description of the figures, and the same elements will not be described further.

The present invention proposes a method in which a source base station, a target base station, and a terminal operate to maintain service continuity and maximize performance of the terminal upon a handover between base stations in a cellular mobile communication system that supports carrier aggregation (CA).

A packet based cellular system considers a Coordinated Multi-point transmission/reception (CoMP) scheme for providing service through a plurality of base stations or a plurality of transmission nodes placed at different geopolitical locations in order to improve the performance of terminals located in cell edges. The CoMP scheme can be generally classified into a CoMP scheme that is provided by one or more micro layer base stations belonging to the service area of a macro layer base station, a CoMP scheme that is provided by two or more macro layer base stations, and a CoMP scheme that is provided by two or more macro layer base stations and micro layer base stations belonging to the service areas of the macro layer base stations.

Also, the CoMP scheme can be classified into a Joint Processing (JP) scheme in which a plurality of transmission nodes transmit the same packet information together, and a Coordinated Scheduling/Beamforming (CS/CB) scheme in which a plurality of transmission nodes coordinate with their neighboring nodes to minimize interference in a transmission node.

According to the JP scheme, a plurality of transmission nodes transmit the same information to the same radio resource using the same modulation and encoding methods, that is, a radio resource consisting of the same frequency band and the same transmission time is allocated to a terminal on which the CoMP scheme is performed.

According to the CS/CB scheme, a plurality of transmission nodes share radio resource information, and modulation and encoding information to allocate a radio resource to an arbitrary terminal in such a way to provide the terminal with a service through an optimal radio resource, modulation, encoding, and interference control. That is, the CS/CB scheme is a control method of allowing a plurality of transmission nodes to exchange related information (for example, the magnitudes of interference signals, the magnitudes of signals from a serving cell and a neighboring cell(s), optimal transmission and encoding information such as Precoding Matrix Indicator (PMI) in consideration of a neighboring cell(s), etc.) with each other.

The JP scheme may be classified into Joint Transmission (JT) in view of downlink from a base station to a terminal, and Joint Reception (JR) in view of uplink from a terminal to a base station.

Also, the JP scheme may consider a Dynamic Cell Selection (DCS) method and a Dynamic Point Selection (DPS) method for dynamically selecting transmission nodes that participate in CoMP operation. The DCS/DPS method is aiming at selecting an optimal point (or cell) at an arbitrary transmission time from among a plurality of cells or points set to participate in CoMP operation, in consideration of radio channel quality, the load statuses of base stations, the transmission/reception power and interference state between a terminal and base stations, etc., thereby improving performance.

In a heterogeneous network environment where a plurality of base stations placed at different geopolitical locations have to support the CoMP scheme, a mobility management method which can improve interference control performance and increase transmission speed by allowing a plurality of nodes to exchange control information or data packets with each other is needed rather than a conventional handover method.

Heterogeneous Network Environment According to the Present Invention

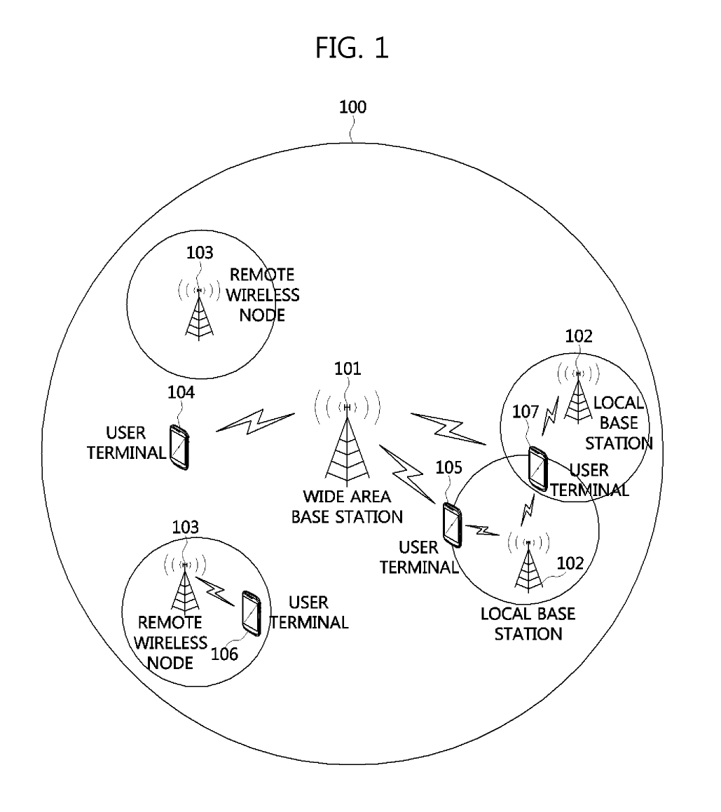

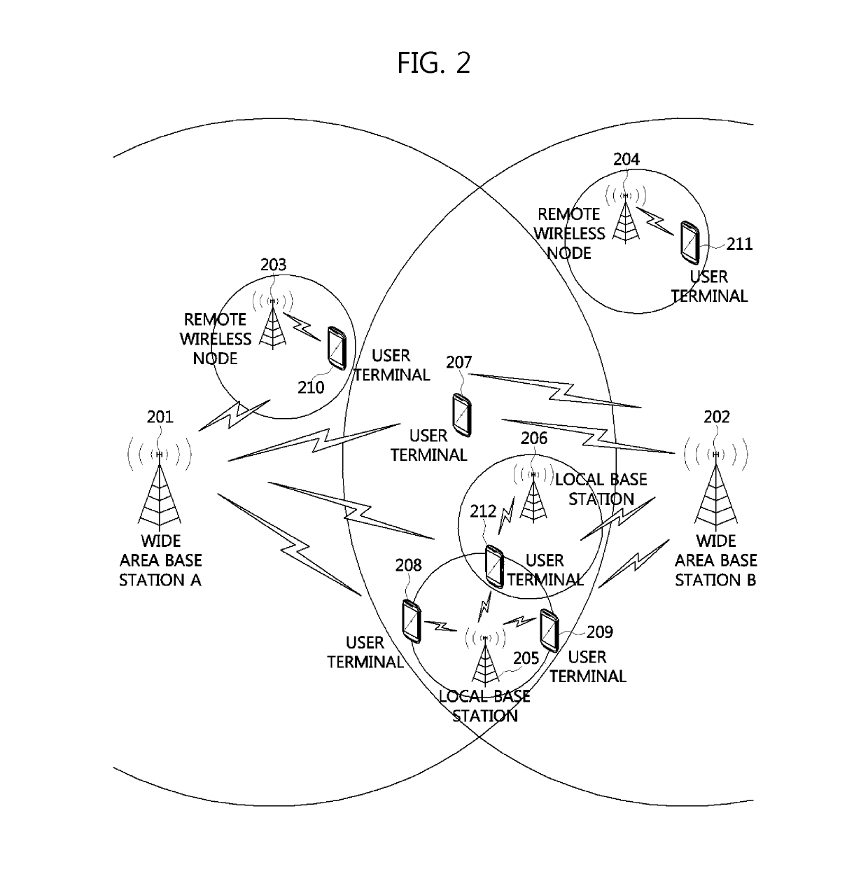

Hereinafter, a heterogeneous network environment to which a mobility management method according to the present invention is applied, and components configuring the heterogeneous network environment will be described with reference to FIGS. 1 and 2.

FIG. 1 is a view for explaining the concept of an intra-evolved Node B (intra-eNB) environment among heterogeneous network environments, and FIG. 2 is a view for explaining the concept of an inter-evolved Node B (inter-eNB) environment among heterogeneous network environments.

Under the heterogeneous network environments that will be described with reference to FIGS. 1 and 2, in a 3GPP-based mobile communication system, a macro layer base station may be an evolved Node B (eNB) or a macro eNB, and a remote wireless node, unlike the macro layer or micro layer base station having all functions of wireless protocol layer 3 (for example, the Radio Resource control (RRC) layer of a LTE system) and wireless protocol layer 2 (for example, the Radio Link Control (RLC)/Medium Access Control (MAC) layer of the LTE system), may be a wireless transmission node having a part of such functions. Or, the remote wireless node may be a wireless transmission node having the functions of a Radio Frequency (RF) module such as a Remote Radio Head (RRH) with an antenna system or having a part of baseband functions. Also, the micro layer base station may be a micro cell, a pico cell, a femto cell, a home cell, or a home eNB having a small service area due to a relatively low transmission power or capable of providing service only in parts (subframes) of radio frames, although the micro layer base station has radio protocol functions including the functions of the RRC layer and the RLC/MAC layer of managing radio resource allocation and connection control of a radio bearer established between the micro layer base station and a terminal, like eNB or a macro layer base station.

FIG. 1 is a view for explaining the concept of an intra-evolved Node B (intra-eNB) environment among heterogeneous network environments.

Referring to FIG. 1, one or more micro layer base stations 102 (102 for each) or one or more remote wireless transmission nodes 103 (103 for each) may exist in a cell 100 of a macro layer base station 101.

According to a system configuration, the micro layer base stations 102 or the remote wireless transmission nodes 103 may be configured to operate using the same cell identifier (ID) as that used by the macro layer base station 101, or a cell ID(s) that is different from that used by the macro layer base station 101.

However, even when the micro layer base stations 102 or the remote wireless transmission nodes 103 are configured to operate using the same cell ID as that used by the macro layer base station 101, separate IDs, patterns for Reference signals (RSs) or pilot symbols for identifying the transmission nodes 103, patterns of scramble signals, etc. may be used to identify the micro layer base stations 102 or the remote wireless transmission nodes 103 for DCS/DPS, interference control between the remote wireless transmission nodes 103, or configuration and identification of feedback information from a terminal. The patterns may be varied according to the transmission locations of the corresponding symbols or signals, transmission frequency bands, transmission intervals or periods, transmission repetition periods, masking signal sequences, etc.

Terminals may receive/transmit packet information from/to one or more points in the heterogeneous network environment where the macro layer base station 101, the micro layer base stations 102, and the remote wireless nodes 103 coexist. Here, the point may be one of the macro layer base station 101, the micro layer base stations 102, and the remote wireless transmission nodes 103, and may function as a transmission point, a reception point, or a transmission and reception point, etc. according to connection management for transmission of packet information and parameter setting information.

Accordingly, there may be a user terminal 104 that establishes a logical connection (for example, an RRC connection of the LTE system) to the macro layer base station 101 to exchange packet information with the macro layer base station 101, and a user terminal 106 that establishes a connection to the macro layer base station 101 to exchange packet information through a remote wireless transmission node 103. Also, there may be a user terminal 105 that transmits or receives packet information through two points of the macro layer base station 101 and the micro layer base station 102, and a user terminal that transmits or receives packet information through two micro layer base stations 101 or two remote wireless transmission nodes 103. In the intra-eNB environment, a user terminal performs control/management for establishing, maintaining and changing a connection to a macro layer base station or a primary transmission node having a layer 3 function (for example, the RRC layer of the LTE system) that is in charge of a control with respect to a connection of a radio bearer regardless of the locations or number of points transmitting or receiving packet information. The primary transmission node may be a base station or a node that is in charge of RRC connection establishment/management and creation and transmission of radio resource allocation information (for example, scheduling information) that is transmitted through a physical layer control channel, regardless of the type (for example, a macro layer base station, a micro layer base station, a remote wireless node, etc.) of the base station. In regard of the user terminal 107, one of two micro layer base stations 102 functions as a primary transmission node. A primary transmission node may be selected by allowing a terminal to select an arbitrary transmission node. Alternatively, a mobile network may select an appropriate transmission node as a primary transmission node, using report information (for example, measured information such as signal magnitudes/interference magnitudes, the corresponding terminal's preference information, or mobility state information) received from the terminal, priority information set by the mobile network, information about the load states of individual nodes, information about the terminal's mobility state estimated by base stations, etc.

Accordingly, the macro layer base station or the primary transmission node may manage a connection control procedure of establishing, maintaining, or changing a connection of a signaling radio bearer for transmitting signaling information, or a radio bearer for data transmission of a transmission node(s) or transmission point(s) in a service area. Also, the node(s) or point(s) may manage a radio control channel establishment and allocation procedure for transmitting control signaling information, including setting frequency-domain (for example, subcarriers) and time-domain (for example, transmission subframes) allocation information about transmission radio resources, setting physical layer control parameters, configuring feedback information, etc.

The user terminals perform a control procedure for deciding points or transmission nodes for transmitting or receiving packet information and control information, through measurement and reporting with respect to points, resource allocation and scheduling (including creation and transmission of PDCCH(PHYSICAL DOWNLINK CONTROL CHANNEL) information, configuring feedback information, etc.), and radio bearer connection control signaling, for CoMP operation with the corresponding macro layer base station (or the corresponding primary transmission node).

FIG. 2 is a view for explaining the concept of an inter-evolved Node B (inter-eNB) environment among heterogeneous network environments.

Referring to FIG. 2, in the inter-eNB environment, macro layer base stations 201 and 202 may perform connection control with respect to user terminals belonging to their service areas, respectively.

If the macro layer base stations 201 and 202 support a CoMP function for a user terminal 207 located in the edge area of their service areas, for a user terminal 212 located in the edge areas of the service areas of points such as micro layer base stations or remote wireless transmission nodes that are managed by the respective macro layer base stations 201 and 202, and for user terminals 208, 209 and 210 that are in the service area of a point that is managed by each macro layer base station 201 or 202 and in the edge area of another macro layer base station, the macro layer base stations 201 and 202 select points that are to participate in CoMP operation and a macro layer base station (that is, a primary eNB) that primarily performs connection control, by exchanging control information. The primary eNB may be, as described above with reference to FIG. 1, selected by a terminal or by a mobile network.

The primary macro layer base station (a primary eNB) primarily decides and performs procedures, such as control parameters setting, connection control (including setting or allocation of a radio control channel for transmitting control signaling information, such as control information and feedback information, etc.) of establishing, maintaining, and changing a connection of a signaling radio bearer, etc. for transmitting a radio bearer or signal information for data transmission, measurement and report on points for CoMP operation, resource allocation and scheduling (including creation and transmission of PDCCH(PHYSICAL DOWNLINK CONTROL CHANNEL) information, configuration of feedback information, etc.), connection control for a radio bearer, etc.

CoMP-Related Parameters and Method of Using the CoMP-Related Parameters, According to the Present Invention

In the heterogeneous network environments described above with reference to FIGS. 1 and 2, the macro layer base station (the primary eNB in the case of FIG. 2) or the primary transmission node may decide a CoMP operation mode, such as JP, DCS/DPS, CS/DB, etc., to be applied to an arbitrary terminal, based on the results of measurements measured and reported by terminals, and uplink radio channel quality, the load states of base stations, degrees of interference, etc. with respect to the terminals, measured by the base stations, and may decide points that are to actually participate in CoMP operation.

Control messages for the CoMP operation mode, points that are to participate in CoMP operation, measurement/report parameters used during CoMP operation, etc. may be set through layer 3 control messages (for example, RRC messages in a 3GPP-based mobile communication system). For example, the RRC control messages may be configured by adding CoMP-related parameters to “RRRConnectionReconfiguration” or “RadioResourceConfigDedicated” messages, etc. used in a 3GPP-based LTE system, or by newly defining RRC control messages for CoMP operation. The RRC control messages for CoMP operation may be configured to include parameters as follows:
CoMP operation mode
   JP, DCS/DPS, CS/CB, or their combination
   CoMP operation link setting information (downlink or uplink, downlink and uplink, and decoupling of downlink and uplink)
Reference time at which CoMP operation starts
   Radio frames, radio subframes, radio slot information, and its related offset information
Information about points that participate in CoMP operation
   Point IDs (physical cell IDs (PCIs)), cell IDs, RRH IDs
   Primary eNB/cell ID, scheduling ID (C-RNTI)
   Information (location, pattern or scramble information of CRS, DM-RS, CSI-RS) about a reference signal (RS) of each point
Information related to JP and CS/CB
   Setting formation of parameters including physical layer parameters for supporting JP and CS/CB CoMP
Setting parameters for CoMP operation
   Information about a threshold value or reference value for entering/starting/releasing CoMP operation

The above parameters may be configured as different control messages according to the case (non-transparent) where each terminal recognizes CoMP operation, and the case (transparent) where each terminal cannot recognize CoMP operation. That is, some CoMP operation modes may be controlled such that each terminal performs CoMP operation without recognizing CoMP operation.

For example, like CoMP according to the JP scheme, in the case where a plurality of transmission nodes transmit the same packet information at the same frequency band and at the same transmission time using the same modulation and decoding methods, each terminal can perform CoMP operation although it does not recognize that a plurality of transmission nodes participate in CoMP operation, if a primary base station or a primary transmission node creates scheduling information and other nodes participating in CoMP operation transmit packet information. At this time, the scheduling information, created by the primary base station or the primary transmission node, however, may be transmitted by only the primary base station or the primary transmission node or through all the transmission nodes that participate in CoMP operation.

As such, in the CoMP according to the JP scheme, if scheduling information is transmitted by only the primary base station or the primary transmission node, dynamic allocation of radio resources is easy. However, if scheduling information is transmitted by all base stations that participate in CoMP operation, a little delay may occur or only limited scheduling such as Semi-Persistent Scheduling (SPS) in a predetermined range may be allowed, since the scheduling information has to be transmitted to all the transmission nodes, according to the configuration of CoMP, specifically, in the inter-eNB. However, in the CoMP environment as illustrated in FIG. 1, since such a delay for sharing scheduling information can be ignored, dynamic creation and transmission of scheduling information is possible, which makes better use of radio resources upon CoMP.

Hereinafter, the CoMP-related parameters will be described in detail.

1) Details About CoMP Operation Mode Parameters

CoMP operation mode parameters may include information indicating an operation mode (that is, JP (can be classified into JT or JR), DCS, CS/CB, or their combination) in which CoMP is performed.

CoMP operation link setting parameters are information representing whether CoMP operation is dedicated to downlink (DL) or to uplink (UL), applied to both DL and UL, or performed through decoupling of DL and UL.

Here, decoupling of DL and UL corresponds to the case where DL and UL transmissions are done with respect to different points on DL and UL. For example, decoupling of DL and UL means a method in which an arbitrary terminal receives DL data from a macro layer base station and transmits UL data to a micro layer base station(s) or a remote wireless node(s), or vice versa.

That is, DL control information or DL data transmission is performed by a macro layer base station, and its feedback control information or feedback data is transmitted to a micro layer base station(s) or a remote wireless node(s). Accordingly, if a primary base station is a macro layer base station, UL feedback control information has to be transferred from a micro layer base station(s) or a remote wireless node(s) to a macro layer base station. Therefore, the primary base station receives the UL feedback control information transmitted from the terminal through the micro layer base station(s) or the remote wireless node(s), creates scheduling information for UL as well as DL, and transfers the scheduling information to DL. The terminal receives the scheduling information for DL and UL and DL data from the macro layer base station, and transmits UL feedback information including HARQ information and UL data to the micro layer base station(s) or the remote wireless node(s).

When CoMP operation is performed through decoupling of DL and UP, different primary base stations or transmission nodes for DL and UL may be configured. In this case, a primary base station or transmission node for each of DL and UL functions as a primary base station with respect to transmission of control information and data, including creation of scheduling information for DL or UP, and the individual primary base stations may share information about terminals by exchanging related control information with each other.

2) Details About CoMP Operation Time Information Parameters

Reference time information parameters for starting CoMP operation are used to inform of at least one of a specific radio frame, a specific radio subframe, and a specific radio slot, from which a terminal has to start CoMP operation.

For example, the reference time information parameters may be configured to include information about reference radio frame, reference radio subframe, reference radio slot, etc., and additionally include offset values with respect to the corresponding reference frame, the corresponding reference subframe, the corresponding slot, etc.

3) Details About CoMP Operation Point Information Parameters

Information about points that participate in CoMP operation, which is information about points that actually participate in CoMP operation, includes ID information for identifying points, ID information of eNB or a cell for primarily controlling CoMP operation, location, pattern, and scramble information of Common RSs (CRSs), DM-RS (or UE-specific reference signals), and CSI-RS (Channel State Information-RS), which are downlink RSs of the individual points, common scheduling ID (for example, C-RNTI) information that is to be applied upon CoMP, etc. Here, the scheduling ID may vary depending on the state of CoMP operation, or may be C-RNTI that has been used before CoMP operation.

If nodes participating in CoMP operation have the same cell ID, C-RNTI can be used as it is. However, if nodes participating in CoMP operation have different cell IDs, a common C-RNTI may be newly allocated through consultation between a CoMP primary base station and the nodes participating in CoMP opreation.

In this case, the corresponding system or cell(s) may reserve and allocate a part of C-RNTI as IDs dedicated to CoMP operation. As such, by allocating a part of C-RNTI being scheduling IDs as IDs dedicated to CoMP operation, it is possible to prevent an arbitrary cell from confusing scheduling IDs of terminals that can support CoMP with scheduling IDs of terminals that cannot support CoMP, and accordingly determination on whether a terminal can support CoMP or whether a scheduling radio resource can support CoMP is possible by using only scheduling IDs.

The ID information for identifying points is information for identifying a macro layer base station, a micro layer base station(s) or a remote wireless transmission node(s) participating in CoMP operation, and may be existing cell IDs, separate IDs that are different from the existing cell IDs, patterns for reference signals (RSs) or pilot symbols for distinguishing transmission nodes from one another, or patterns of scramble signals, etc.

The patterns may be differentiated using transmission locations, transmission frequency bands, transmission intervals or periods, or transmission repetition periods of the corresponding symbols or signals, or the masking signal sequences for the symbol patterns or the scramble signals, etc. Also, it is possible to set validity of the corresponding information in unit of subframe using information about an arbitrary subframe that performs CoMP operation. For example, it is possible to control such that CoMP resources are allocated using Semi-Persistance Scheduling.

4) Details About Information Parameters Related to Supporting JP or CS/CB CoMP

Setting information of parameters including physical layer parameters for supporting JP or CS/CB CoMP may be transferred using a semi-static method.

Information parameters related to supporting JP or CS/CB CoMP may include radio resource allocation information for supporting CoMP by a plurality of nodes, feedback parameters (PMI, CSI, RI (Rank Indicator)) setting information, frequency band deployment information for avoiding interference, and related precoding matrix indicator (PMI) information, beam pattern and beam sweeping information, optimal beamforming information, or information about a cell/node of primarily controlling CoMP, etc.

5) Details About CoMP Operation Parameters

CoMP operation parameters are threshold values or reference values for parameters for entering a CoMP operation mode, starting CoMP operation, or releasing CoMP operation.

The threshold values or reference values may include a threshold value or an offset value for controlling CoMP operation of Reference Signal Received Power (RSRP) or Reference Signal Received Quality (RSRQ) which are parameters to be measured, a threshold value or an offset value for a timer for managing a connection of a radio channel or a radio bearer, an event triggering threshold value or an offset value for mobility management, a parameter related to monitoring of a ping-pong handover or a transmission point (or a transmission node) change, etc.

Here, the timer may be a timer for controlling a handover, a timer for controlling radio link failure (RLF), a timer for controlling radio link recovery, a timer for controlling CoMP operation, a timer for controlling discontinuous reception (DRX), etc.

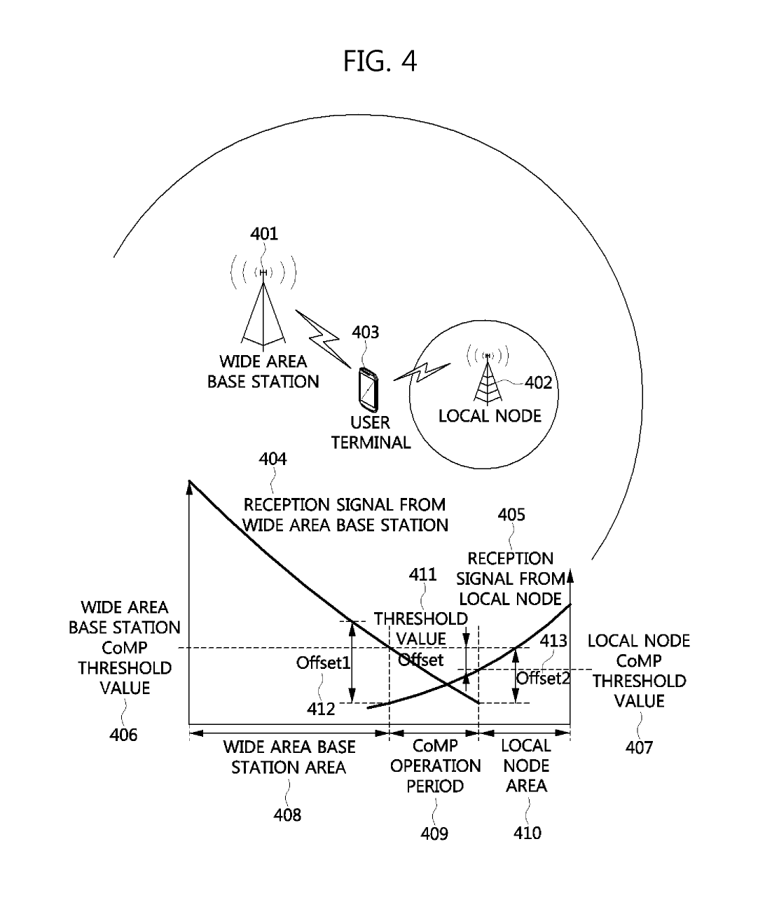

A parameter for event triggering for mobility management may be a threshold value or an offset value (for example, a threshold value or an offset value that will be described later with reference to FIG. 4) for entering or releasing each event based on measured values (RSRP or RSRQ) with respect to a serving cell or neighboring cells for mobility management.

The parameter related to monitoring of a ping-pong handover or a point change may be a timer for monitoring the frequency at which points (or transmission nodes) change or a handover occurs for an arbitrary time period set by the corresponding system or base station or the frequency at which a ping-pong handover or ping-pong of a point change happens for a predetermined time in an arbitrary cell or point, a setting value for counter, etc.

Also, in order to set DRX for minimizing consumption power of terminals (for example, terminals that are in a RRC_Connected state or in an active state) that maintain a RRC connection to a base station, related parameters are defined and the corresponding values are set.

Parameters for DRX of terminals that maintain a RRC connection to a base station may include a DRX cycle, a DRX inactivity timer, a retransmission timer, etc. In regard of the DRX cycle, parameters for a short DRX cycle and a long DRX cycle may be set. A terminal starts DRX when it receives a control message for instructing to perform DRX or when the DRX inactivity timer terminates. The terminal applies the short DRX timer using a separate timer (for example, a DRX short cycle timer) for defining a period for which the short DRX cycle is applied, thereby setting a time period for which DRX is performed. When the “DRX short cycle timer” terminates or when only the long DRX cycle is set, the long DRX period is applied to perform DRX.

Method for Managing Measurement for Mobility Management, According to the Present Invention

Terminals (for example, terminals that are in a RRC_Connected state or in an active state) that maintain a RRC connection to a base station define related parameters and set the corresponding values in order to set measurement or measurement report operation for the purpose of mobility management such as a handover.

Information about threshold values or reference values for timers, events, and reception signals for entering/starting/releasing CoMP operation, which are parameters for CoMP operation among the parameters, controls the terminals to perform appropriate measurement. In order to determine whether to perform CoMP operation and decide a CoMP method, the above-mentioned parameters may be, before CoMP operation is performed, transferred to a terminal through a separate control message that is different from a RRC message such as “RRRConnectionReconfigiuration” or “RadioResourceConfigDedicated”, or through a RRC control message (for example, “measObjectToAddModList” or “reportConfigToAddModList”) related to setting of measurement or measurement report.

Also, the terminals that maintain the RRC connection to the base station perform measurement on a serving base station and neighboring base stations (the same frequency or the neighboring frequencies) in order to support a mobility function, and report the results of the measurement to the base station according to a measurement and measurement report parameter set by the base station through a separate control message.

The base station informs the terminals of information indicating base stations to be measured, parameters to be measured, a measurement period, a measurement report period, and parameters related to conditions for entering and releasing a measurement event, through control messages, and the terminals perform measurement according to the set parameters and report the results of the measurement.

The base stations to be measured may be represented using base station IDs, for example, RSRP, RSRQ, RSSI, etc. The parameters related to conditions for entering and releasing the measurement event may be set using a threshold value or an offset value for controlling CoMP operation, a threshold value for a timer(s) for managing a connection of a radio channel or a radio bearer, an event triggering threshold value or an offset value for mobility management, a parameter related to monitoring of a ping-pong handover or a transmission point (or transmission node) change, etc.

Events for mobility management include cases as follows:
A case where a reception signal value (or a channel quality value) of a serving base station while maintaining a RRC connection to the corresponding terminal is good or bad compared to a threshold value
A case where a signal from a neighboring base station (the same frequency or a different frequency) is good or bad with respect to a predetermined degree (for example, an offset value), compared to a signal from a serving base station
A case where signals from a serving base station and neighboring base stations satisfy the conditions for CoMP operation as described above
A case where if carrier aggregation (CA) is supported, a condition for changing a primary cell (PCell) or a secondary cell (SCell) for CA is satisfied
A case where a base station satisfies a condition for stopping or resetting measurement and measurement report.

The measurement period and the measurement report period may be set in unit of subframe or frame, when a periodic method is used, and the measurement report period may be set to be aligned with a multiple of a DRX cycle in order to maximize DRX performance.

The measurement period and the measurement report period may be set by an aperidic method of reporting measurement when an event has occurred, regardless of a set measurement period or a set measurement report period, if a condition for entering and releasing a mobility-related event is satisfied.

The terminals that maintain the RRC connection to the base station, needing DRX, and measurement and measurement report, may be disconnected from the base station and enter an idle state when no data is exchanged between the terminals and the base station for a predetermined time period, or when the base station determines that the RRC connection is no longer needed, for efficiency of operation.

However, in order to avoid overhead of a signaling procedure required for changing (idle state<->RRC-connected state) the states of the terminals, to minimize power consumption required for DRX and measurement/measurement report, and to improve use efficiency of radio resources such as a control channel occupied for measurement report, instead of changing the states of the terminals, the terminals may be controlled such that measurement or measurement report is stopped in the following cases.

For example, if no data is exchanged between the base station and the terminals for a predetermined time period, if no event related to measurement is generated for a predetermined time period, if a difference (deviation) between measurement report values is below a predetermined value, if the terminals are determined to have low mobility according to the result of mobility state estimation on the terminals, if the terminals are located in a predetermined area (in a limited service area) (for a predetermined time period?), if the terminals access a specific node to be able to recognize that mobility is limited, or if a measurement report value satisfies a condition of a pre-defined value (threshold value), the terminals may be controlled such that measurement or measurement report is selectively stopped.

In addition to this, the base station and the terminals may use an expanded measurement period or an expanded measurement report period according to a predetermined method. That is, if the condition for stopping the measurement/measurement report is satisfied or if a separately set condition is satisfied, a measurement period and a measurement report period that are longer than an existing measurement period or an existing measurement report period, respectively, can be used, and for this, the base station may transmit a separate control message to the terminals to stop a measurement report or to expand a measurement period.

In order to decide measurement and measurement report parameters for the terminals, including stopping measurement report or expanding a measurement report period, the base station and the terminals may define a timer for defining a time period for which the terminals maintain a RRC connection to the base station without exchanging data with the base station, or a time period for which no measurement-related event occurs, wherein the timer value is set to be variable. Also, a difference (deviation) between measurement report values of the terminals, a measurement report level, a measurement report threshold value, etc. for determining whether to stop a measurement report or to expand a measurement report period are defined, and the values also may be set to be variable. The timer values, the deviation, and the threshold values, which are parameters for determining whether to stop a measurement report or to expand a measurement report period, may be set through control messages, and also triggering for stopping a measurement report or expanding a measurement report cycle may be performed. A control message for informing information related to stopping a measurement report or expanding a measurement report period, or for signaling instructing to stop a measurement report or to expand a measurement report period may be a RRC control message, a MAC control message (control PDU), a physical control channel, etc.

A terminal instructed to stop a measurement report or to perform operation of expanding a measurement report period may stop measurement or measurement report or perform measurement report according to the expanded measurement report period, even when the terminal maintains a RRC connection to a base station. However, if the terminal receives a control message for informing reception of data from the base station, or if the terminal generates information that has to be transmitted to the base station, the terminal may perform measurement and measurement report according to control messages (for example, “measObjectToAddModList” and “reportConfigToAddModList”) of the previously set measurement period and the previously set measurement report period. Otherwise, when data is again exchanged between the base station and the terminal, a reconfiguration procedure may be performed through control messages for a measurement period and a measurement report period.

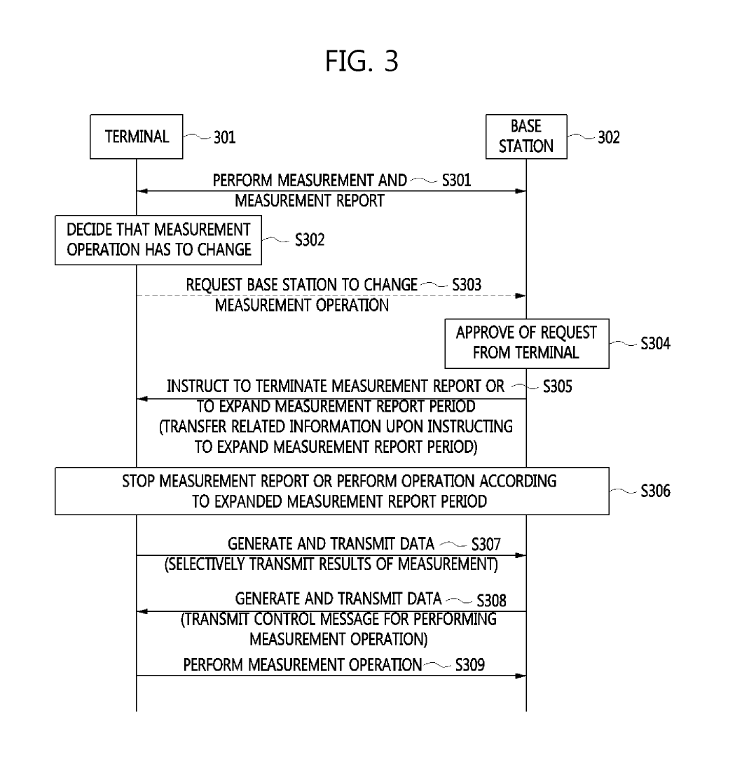

FIG. 3 is a flowchart illustrating a method of managing measurement operation for mobility management in a heterogeneous network environment, according to an embodiment of the present invention.

FIG. 3 corresponds to a flowchart of messages for performing a procedure for changing, stopping, and reconfiguring measurement operation.

First, a terminal 301 performs measurement and measurement report operation according to measurement-related parameters set by a base station 302 (S301).

Then, if the above-described condition is satisfied, or if the related timer terminates, the terminal 301 determines that the measurement report operation has to terminate or that a measurement report period has to be expanded (S302), and requests the base station 302 to stop measurement report operation or expand the measurement report period (S303). The base station 302 approves of the request from the terminal 301, or determines that the measurement operation has to change if the base station 302 satisfies the above-described condition or if the related timer terminates, regardless of a request from the terminal 301 (S304).

The base station 302 transmits a base station control message to the terminal 301 to instruct to change the measurement operation (305). At this time, parameter information for setting required measurement operation-related parameters may be transmitted to the terminal 301.

The terminal 301 that has received the control message for changing the measurement operation stops the measurement report or performs measurement report according to an expanded measurement report period (S306).

If the terminal 301 generates data, the terminal 301 may selectively transmit the results of measurement while transmitting information according to a data transmission request procedure (S307). Meanwhile, if the base station 302 generates data, the base station 302 instructs the terminal to receive downlink data, and transmits related parameters for performing measurement operation to the terminal 301 through a control message while transmitting the data (S308).

The terminal performs measurement operation according to the reconfigured measurement operation parameter (S309). In operations S305, S307, and S308, the measurement-related control message may be transmitted as one message or divided into two or more messages and transmitted according to a radio channel environment or according to the states of available radio resources.

Also, even when there is no request for changing measurement operation of the terminal in operation 303, the base station may control the terminal to change measurement operation, to stop measurement report, or to expand the expanded measurement report period, as necessary.

Method for Mobility Management in Heterogeneous Network Environment, According to the Present Invention

FIG. 4 is a view for explaining a method in which a plurality of base stations or a plurality of transmission nodes support CoMP operation and perform mobility management in a heterogeneous network environment, according to an embodiment of the present invention;

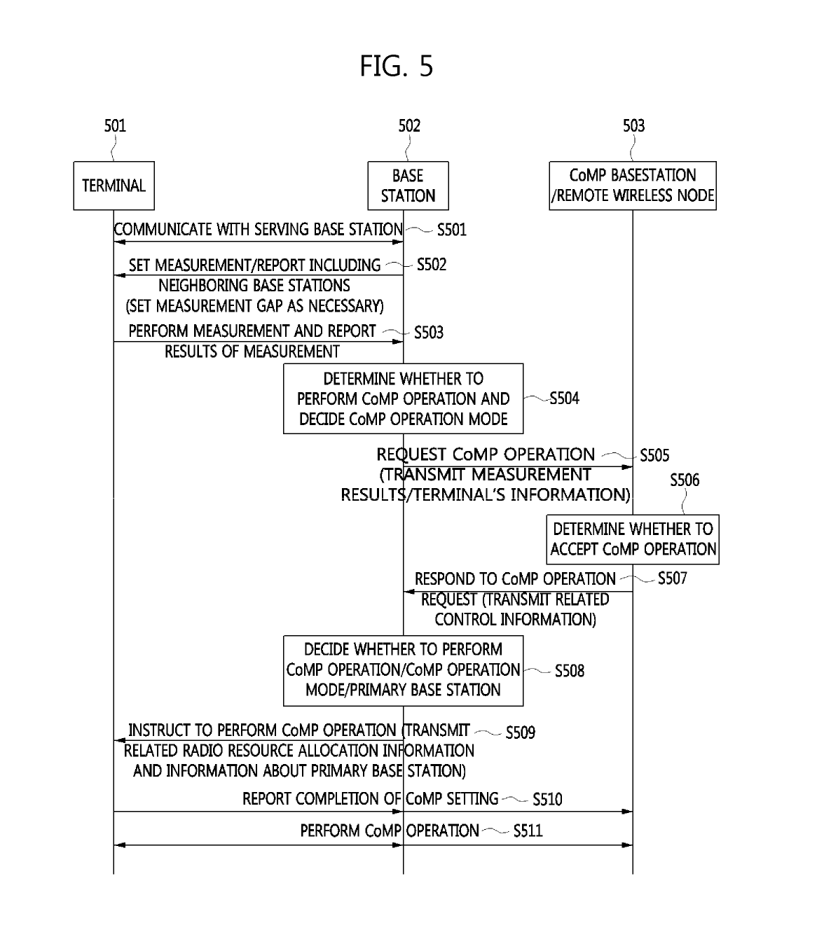

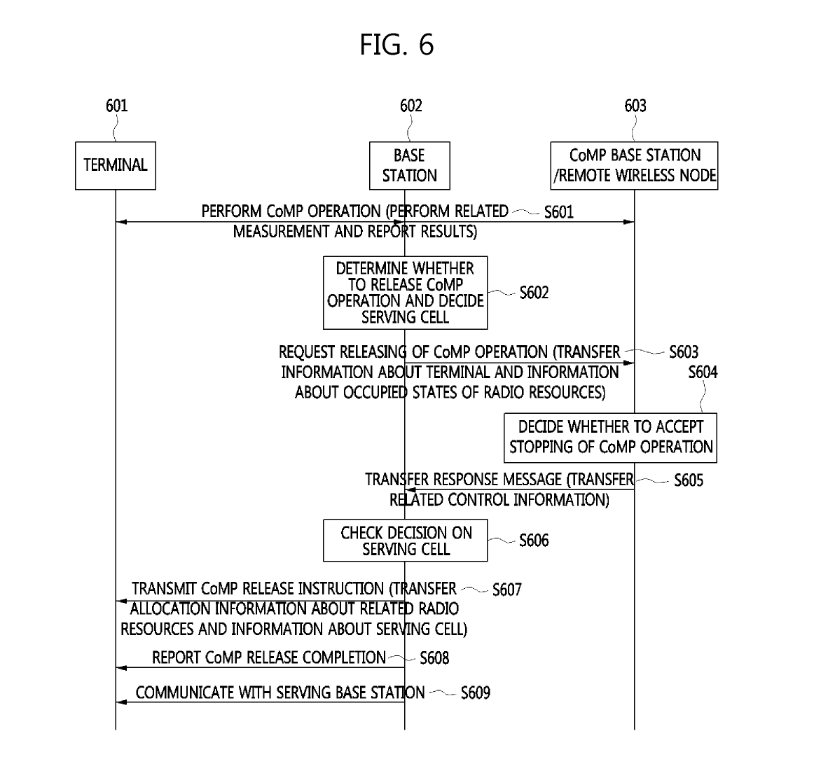

In the environment in which CoMP operation is supported and mobility is managed as illustrated in FIG. 4, a mobility management method in consideration of entering CoMP operation, and a mobility management method in consideration of releasing CoMP operation will be described with reference to FIGS. 5 and 6, later.

FIG. 4 shows an example in which a terminal 403 located between a macro layer base station 402 and a local node 402 (a remote wireless node, a micro layer base station, a femto cell, a Home eNB, or a Closed Subscriber Group (CSG) cell) enters CoMP operation and releases CoMP operation according to a reception signal 404 from the macro layer base station 401 and a reception signal 405 from the local node 402.

If the magnitude of the reception signal 404 from the macro layer base station 401 is greater than a macro layer base station CoMP threshold value 406, or if a difference between the reception signal 404 from the macro layer base station 401 and the reception signal 405 from the local node 402 is greater than a threshold offset 411, the terminal 403 receives service only from the macro layer base station 408 without performing CoMP operation since the terminal 403 belongs to the service area 408 of the macro layer base station 401.

Meanwhile, if the magnitude of the reception signal 405 from the local node 402 is greater than a local node CoMP threshold value 407, or if the magnitude of the reception signal 405 from the local node 402 is greater than a threshold offset 411, the terminal 403 receives service only from the local node 402 without performing CoMP operation since the terminal 403 belongs to the service area 410 of the local node 402.

The macro layer base station CoMP threshold value 406 represents a threshold value condition based on which a terminal belonging to the service area of a macro layer base station performs CoMP operation, and the local node CoMP threshold value 407 represents a threshold value condition based on which a terminal belonging to the service area of a local node performs CoMP operation. The threshold offset 411 may represent a difference between the macro layer base station CoMP threshold value 406 and the local node CoMP threshold value 407, or represent a relative difference of the reception signal 405 from the local node 402 with respect to the reception signal 404 from the macro layer base station 401. That is, it is possible to control the terminal to perform CoMP operation if the difference between the reception signals 404 and 405 from the two nodes 401 and 402 is below the threshold offset 411.

Also, if the magnitude of the signal 404 received by the terminal 403 from the macro layer base station is smaller than the macro layer base station CoMP threshold value 406, and the magnitude of the signal 405 received by the terminal 403 from the local node 402 is smaller than the local node CoMP threshold value 407, or if the difference between the reception signals 404 and 405 from the two nodes 401 and 402 is below the threshold value offset 411, it is possible to perform CoMP operation under cooperation of the macro layer base station 401 and the local node 402.

There is the case where when the terminal 403 that is performing CoMP operation moves toward the local node 402, the reception signal 404 from the macro layer base station 401 becomes too weak to perform CoMP operation since the difference between the reception signal 404 from the macro layer base station 401 and the reception signal 405 from the local node 402 is greater than a predetermined offset (Offset2) 413. Also, there is the case where the magnitude of the reception signal 405 from the local node 402 is greater than the local node CoMP threshold value 407, or the case where the difference between the reception signal 405 from the local node 402 and the reception signal 404 from the macro layer base station 401 is above the threshold offset 411. In these cases, it is possible to control the terminal to release CoMP operation and receive service only from the local node 402.

Also, there is the case where when the terminal 403 that is performing CoMP operation moves toward the macro layer base station 401, the reception signal 405 from the local node 402 becomes too weak to perform CoMP operation since the difference between the reception signal 404 from the macro layer base station 401 and the reception signal 405 from the local node 402 is greater than a predetermined offset (Offset1) 412. Also, there is the case where the magnitude of the reception signal 404 from the macro layer base station 401 is greater than the macro layer base station CoMP threshold value 406, or the case where the difference between the reception signal 404 from the macro layer base station 401 and the reception signal 405 from the local node 402 is above the threshold offset 411. In these cases, it is possible to control the terminal to release CoMP operation and receive service only from the macro layer base station 401. Here, the offsets Offset1 and Offset2 each may be not a difference between reception signals from the plurality of transmission nodes, but a relative difference between threshold values for the reception signals or between the CoMP threshold values 406 and 407.

That is, if the arbitrary terminal 403, the macro layer base station 401, and the local node 402 support a CoMP function, the terminal 403 belongs to a macro layer base station area 408, a CoMP operation period 409, and a local node area 410 when the terminal 403 moves in the direction from the macro layer base station 401 to the local node 402 according to a change in the mobility and radio channel environment, so that the terminal 403 receives service only from the macro layer base station 401, and then receives service from all the macro layer base station 401 and the local node 402, and finally when the terminal 403 approaches the local node 402, the terminal 403 belongs to the local node area 410 to thus receive service only from the local node 402. If the terminal 403 moves in the direction from the local node 402 to the macro layer base station 402, a service area changing scenario of the local node area 410→the CoMP operation period 409→the macro layer base station area 408 is taken.

That is, in a heterogeneous network environment, instead of a handover due to movement to a different base station or a different cell, a service scenario in which a terminal receives service from only a base station, a cell, or a transmission node, is subject to a CoMP operation period in which the terminal receives service from two or more base stations, cells or transmission nodes, and then again the terminal receives service from only a base station, a cell, or a transmission node, is taken.

If any one of the terminal 403, the macro layer base station 401, and the local node 402 does not support the CoMP function, according to the conventional mobility management, the terminal 403 is not subject to the CoMP operation period 409, and a handover procedure from the macro layer base station area 408 to the local node area 410, or from the local node area 410 to the macro layer base station area 408 will be performed.

As described above, as basic parameters for preparing, starting, and releasing (stopping) CoMP operation, reception signals from nodes, threshold value parameters, and measured information on the mobility state of a terminal can be used as information for setting CoMP operation. For example, if the terminal moves at high speed, it is possible to control the terminal to start CoMP early and release the CoMP late in order to avoid call drop or handover failure. That is, by setting a plurality of threshold parameters for CoMP operation and applying different threshold values according to measured values on the mobility state of a terminal, it is possible to improve the efficiency of CoMP operation. Also, in the case of control using the same threshold value, it is also possible to differentiate timer values needed for a triggering procedure according to measured values on the mobility state of a terminal in individual stages of preparing, starting, and releasing (stopping) CoMP operation.

FIG. 5 is a flowchart illustrating a method of managing mobility in consideration of start of CoMP in a heterogeneous network environment, according to an embodiment of the present invention.

A base station 502 exchanges information about UE capability with a terminal 501 that receives service from the base station 502 (S501) to determine whether the terminal 501 supports a CoMP function. Then, the base station 502 sets parameters related to points to be measured or parameters related to a report period using measurement- or report-related messages in consideration of supporting a CoMP function, as necessary (S502).

In operation 502, the base station 502 may notify the terminal 501 of parameter information related to threshold values or reference values for events, timers, and reception signals for entering/releasing/starting/stopping CoMP operation, which are CoMP-related setting information, through RRC control messages (for example, “measObjectToAddModList”, “reportConfigToAddModList) related to measurement or measurement report setting. At this time, the base station 502 may define a separate control message for setting CoMP operation, as necessary, and notify the terminal 501 of information related to threshold values or reference values for events, timers, and reception signals for entering/releasing/starting/stopping CoMP operation. The base station 502 may transmit setting information about reference signal patterns including transmission periods, transmission locations, encoded formats, etc. of reference signals (or symbols) of base stations that are to be subject to CoMP operation, to the terminal 501. Each reference signal may be a Cell-specific RS specified to a cell, or a UE-specific RS specified to an arbitrary terminal, used for data demodulation, or a Channel State Indication (CSI)-RS used for reporting a channel state.

The terminal 501 performs measurement according to the settings of the base station 501, and reports the results of the measurements (S503). The base station 502 determines whether CoMP operation has to be performed in consideration of radio channel information reported by the terminal 501, radio channel information measured by the base station 502, the load state of the base station 502, available power, influence of interference, etc., and decides a CoMP operation mode (S504).

At this time, in order to estimate influence of interference, the base station 502 may control the terminal 501 to perform measurement and measurement report using an Almost Blank Subframe (ABS) pattern that is applied to macro layer base stations, micro layer base stations, and remote wireless nodes in operation S502 of setting measurement- and report-related parameters.

In a heterogeneous network environment, ABS is an interference control method in which a transmission node or cell interfering neighboring transmission nodes or cells transmits no data at an arbitrary subframe, or transmits data with minimum transmission power at the arbitrary subframe to allow data reception only near the center area of the transmission node or cell to thereby prevent interference with the neighboring transmission nodes or cells. Accordingly, by applying an ABS pattern in a cell or transmission node interfering neighboring nodes or cells, the neighboring transmission nodes or cells can communicate with the terminal, without any interference, using a subframe to which the corresponding ABS pattern has been applied.

That is, by allowing the terminal 501 to measure reception signal information (RSRP or RSRQ) for a subframe to which ABS has been applied and a general frame to which no ABS has been applied, according to the ABS pattern applied to minimize interference between base stations or nodes, the base station 502 compares the results of the measurement and recognizes a degree of interference according to the results of the measurement to thereby determine whether CoMP operation has to be performed in consideration of the degree of interference.

For example, if a difference between a reception signal of a subframe to which ABS has been applied and a reception signal of a subframe to which no ABS has been applied is not great, it can be determined that influence of interference is small, and accordingly, it can be determined that CoMP operation is not needed. However, if a difference between a reception signal of a subframe to which ABS has been applied and a reception signal of a subframe to which no ABS has been applied is great and the resource utilization of the corresponding system is low according to application of ABS, by applying CoMP operation to eliminate interference of terminals that will be subject to CoMP operation and improving the performance of the terminals, it is possible to improve utilization of resources in view of system.

For this, the base station sets a comparison reference value or an offset value with respect to a difference between a reception signal of a subframe to which ABS has been applied and a reception signal of a subframe to which no ABS has been applied, and causes the terminal to perform measurement report or sets an event for reporting to the base station only when the difference between the reception signals is greater than the set value, thereby setting a CoMP operation mode or controlling CoMP operation.

Also, it is possible to divide objects to be measured into subframes to which ABS has been applied or subframes to which no ABS has been applied, according to the locations of the base station 502 and the terminal 501, to measure the objects, and to report the results of the measurement.

For example, in a heterogeneous network environment where a macro layer base station and a local node (a micro layer base station or a remote wireless transmission node) coexist, when the macro layer base station applies an ABS pattern, the macro layer base station controls a terminal to measure and report subframes to which no ABS has been applied when the terminal is located near the macro layer base station, and the macro layer base station controls the terminal to measure and report subframes to which ABS has been applied when the terminal is located near the local node. Also, the macro layer base station controls terminals located between the macro layer base station allowing CoMP operation and the local node to measure and report all subframes to which ABS has been applied and to which no ABS has been applied. As a reference or event condition for such measurement and setting, a comparison reference value or an offset value with respect to a difference between a reception signal of a subframe to which ABS has been applied, and a reception signal of a subframe to which no ABS has been applied may be set and applied. That is, if the difference between the reception signals is smaller than an predetermined offset value and the reception signal from the macro layer base station is greater than a predetermined threshold value, it is determined that the corresponding terminal is located close to the macro layer base station that uses the ABS pattern, and it is possible to perform measurement and report, without any limitation, regardless of subframes to which no ABS pattern has been applied or the ABS pattern. If the difference between the reception signals is greater than the predetermined offset value and the reception signal from the local node is greater than the predetermined threshold value, it is determined that the corresponding terminal is located in an environment with great interference between the macro layer base station and the local node, and it is possible to control terminals to measure and report all subframes to which the ABS pattern has been applied and to which no ABS pattern has been applied.

In the heterogeneous network environment described above, a method of measuring subframes to which the ABS pattern has been applied, of measuring subframes to which no ABS pattern has been applied, or of performing measurement regardless of subframes to which the ABS pattern has been applied and to which no ABS pattern has been applied, according to the locations of nodes and terminals, using the difference between reception signals from two nodes (a macro layer base station and a local node (a micro layer base station, a Closed Subscriber Group (CSG) cell, a home base station, a remote wireless node, etc.)), a threshold value or an offset value with respect to the reception signal difference, and a reception signal value (for example, a value representing radio channel quality and reception signal intensity, such as RSRP, RSRQ, RSSI, a pathloss value, received power, etc.) from each node, may be applied to mobility management (for example, a cell camping procedure or a cell selection/reselection procedure) of terminals (for example, terminals being in an idle state) that are not connected to any cell or base station (node), while supporting a handover or CoMP operation for mobility management for terminals (for example, terminals being in a RRC_Connected state or in an active state) that maintain a RRC connection. That is, a terminal that is in an idle state performs a cell selection/reselection procedure of selecting a cell or a base station that can provide optimal service to the terminal and camping in the selected cell or base station.

Also, the CSG cell means a cell of allowing access of an arbitrary subscriber group to provide service to the subscriber group and disallowing access (including camping) to other subscribers except for the allowed group. Some CSG cells may operate according to a hybrid scheme of allowing only CSG cell subscribers to access a part of resources and opening the remaining resources to all subscribers. Accordingly, in a heterogeneous network environment, CSG cells cause interference to greatly influence a cell selection/reselection procedure by terminals that are in an idle state.

Accordingly, as described above, in a heterogeneous network environment where there is interference between cells or nodes, in order to camp in an optimal cell, different measurement mechanisms may be needed according to whether the ABS pattern is applied, reception signals from a plurality of nodes, differences between reception signals from a plurality of nodes, or whether access to a CSG cell is possible. For such a cell selection and reselection procedure, when a terminal selects an optimal cell through measurement, the terminal may decide whether to perform the cell selection/reselection procedure by measuring a subframe to which the ABS pattern has been applied, whether to perform the cell selection/reselection procedure by measuring a subframe to which no ABS pattern has been applied, or whether to perform the cell selection/reselection procedure by performing measurement regardless of subframes to which the ABS pattern has been applied and to which no ABS pattern has been applied, selectively using the differences between reception signals from a plurality of nodes, a threshold value or an offset value with respect to the reception signal differences, a reception signal value from each node, etc., according to the above-described method.

In operation S504, the serving base station 502 that has decided a CoMP operation mode for the arbitrary terminal 501 transmits a CoMP request message to a base station(s) or a remote wireless node(s) that participate in CoMP operation, as necessary (S505). In operation S505, the serving base station 502 may include the results of measurement by the terminal 501 and information (for example, a service kind, UE capability, etc.) about the terminal 501 in the CoMP request message as necessary. The CoMP base station and the remote wireless node(s) that have received the CoMP operation request may determine whether to accept CoMP operation using the load states of the base station and the remote wireless node, available power, and influence of interference (S506), and transmits a response message responding to the CoMP request together with the related control information (S507). The base station 502 decides a CoMP operation mode and a primary base station based on the request message, the results of the measurement, and the related control information, transmitted from the base station/remote wireless node(s) that participate in CoMP operation (S508).

In the intra-eNB environment illustrated in FIG. 1, the base station 502 primarily determines whether to perform CoMP operation, and decides an operation mode and a node(s) (a micro layer base station(s) and a remote wireless node(s)) that participates in CoMP operation, so that operations S505 through S507 can be omitted, and accordingly, operations S504 and S508 can be simultaneously performed. Operation S508 of deciding a primary base station may be replaced with a procedure of deciding a primary point for CoMP operation, or it can be assumed that the CoMP operation request is decided by a primary node.

However, in the inter-eNB environment illustrated in FIG. 2, operations S505 through S507 may be needed for CoMP-related consultation and related information exchange between two base stations 502 and 503, and operation S508 of deciding a primary base station for CoMP operation control and management is needed. At this time, under an assumption that only the primary base station requests CoMP operation, operation S508 may be omitted.

The primary base station 502 instructs CoMP operation, and at this time, allocation information of related radio resources and information about the primary base station 502 are transmitted (S509). In operation S509, the base station 502 transfers a “CoMP operation mode parameter”, a “reference time at which CoMP operation starts”, “information about points that participate in CoMP operation”, etc., as described above, to terminals, through RRC control messages, and may transfer the related information to base stations/radio wireless nodes that participate in CoMP operation, as necessary. CoMP information notified to the terminals may be selectively configured according to a CoMP method, such as JT, JR, CS/CB, DCS/DPS, and DL/UL decoupling. That is, in operation S502 or S509, a CoMP operation mode, a reference time at which CoMP operation starts, information about points that participate in CoMP operation, information about a CoMP method (for example, information related to JP or CS/CB), setting information of parameters for CoMP, etc., as described in the “CoMP-related Parameters and Method of Using the CoMP-related Parameters” may be selectively configured and notified.

The terminal 501 transmits a CoMP setting completion message to the base station 502 and the CoMP base station/remote wireless node 503 (S510), and performs CoMP operation (S511). Operation S510 of transmitting the CoMP setting completion message may be omitted.

In operation S509, the “reference time at which CoMP operation starts” is not transmitted through a RRC control message, and only setting information about transmission nodes (macro layer base station/micro layer base station/remote wireless node) that participate in CoMP operation is transmitted through a RRC control message. Operation of starting (or stopping) CoMP operation may be performed using a layer 2 control message (for example, a MAC control message of a LTE system) for a separate CoMP activation (or deactivation) procedure, or may be controlled directly using scheduling information using a physical layer control channel (for example, Physical Downlink Control Channel (PDCCH) of a LTE system). For example, CoMP-dedicated C-RNTI may be used, or bit information for informing application of CoMP operation or ID information of a transmission node(s) for CoMP operation is reflected to scheduling information.

That is, setting related to a plurality of nodes that participate in CoMP operation is performed through a RRC control message, and through a MAC control message, a procedure for activation/deactivation of a plurality of nodes set for CoMP is performed to control whether to perform packet information transmission and reception for CoMP of the corresponding node(s). Accordingly, the deactivated node(s) may not instantaneously participate in packet information transmission and reception for CoMP operation although they have been set to node(s) that participate in CoMP operation, and for this, an activation/deactivation procedure can be performed through a MAC control message. The MAC control message may be transmitted through PDSCH or PDCCH.

A direct control method using PDCCH, instead of a MAC control message, is a method of transmitting radio resource allocation information including CoMP through a field parameter in scheduling information of PDCCH of transmitting radio resource allocation information (including modulation and encoding information) for PDSCH.

Among CoMP methods, a DCS method may be used more efficiently in the case of using the MAC control message or the physical layer control channel. That is, it is possible to control in unit of radio frame or subframe through a field parameter in a MAC control message or a PDCCH. The field parameter in the MAC control message or PDCCH may inform information about points for transmitting or receiving packet information for CoMP operation, through cell/point/frequency indexes or ID information for identifying cells/points/frequencies that are transmitted, or the locations (frequency-domain and time-domain information), patterns, transmission or repetition periods, or scramble information of reference signals (RSs) for identifying the corresponding cells/points.

FIG. 6 is a flowchart illustrating a method of managing mobility in consideration of release of CoMP in a heterogeneous network environment, according to an embodiment of the present invention.

Referring to FIG. 6, a terminal 601 that performs CoMP operation with a base station 602 through base stations/remote wireless nodes 603 that participate in CoMP operation, performs measurement according to measurement- or measurement report-related parameters set by the base station 602 (that is, a CoMP primary base station), and reports the results of the measurement (S601).

The CoMP primary base station 602 determines whether to release CoMP operation and decides a serving cell, in consideration of the results of the measurement and call quality (packet error rate, the generation frequency of HARG, etc.) during CoMP operation (S602). The CoMP primary base station 602 may determine whether to stop CoMP operation before deciding to release a CoMP operation mode, control the terminal 601 operating in the CoMP operation mode to receive service through a single node (a base station or a remote wireless node), instead of CoMP, and also stop (deactivate) CoMP operation using a separate MAC control message for stopping (deactivating) CoMP operation or control the terminal directly using scheduling information using PDCCH. The primary base station 602 may decide deactivation of CoMP operation and releasing of the CoMP operation mode simultaneously, or control such that they are sequentially applied.

After deciding releasing of CoMP operation, the base station 602 transfers information about the corresponding terminal 601 and about the occupied states of radio resources, together with a CoMP release request, to a base station(s)/remote wireless node(s) that participates in CoMP operation (S603). The base station(s)/remote radio node(s) 603 that participates in CoMP decides whether to accept stopping of CoMP operation (S604), and transfers a response message to the CoMP primary base station 602 (S605).

Through information exchange with the base station(s)/remote wireless node(s) 603 that participates in CoMP operation, the CoMP primary base station 602 again checks the decision on the serving cell (S606), and transmits a CoMP release instruction to the terminal 601, together with allocation information of radio resources related to the serving cell (S607). Here, a control instruction for stopping or releasing CoMP operation may be transferred through a RRC control message. The RRC control message may be configured through “RRRConnectionReconfiguration” or “RadioResourceConfigDedicated”, and may be configured to include “MobilityControlInfo”.

The terminal 601 transmits a CoMP release completion report message (S608), and receives service through a single serving base station without performing CoMP operation by a plurality of nodes (S609).

In the procedure illustrated in FIG. 6, it is possible that operations S603, S604, and S605 are omitted, operations S602 and S606 are together performed according to the decision of the primary base station 602, and operation S603 is replaced with operation of reporting that CoMP has been released, instead of requesting releasing of CoMP operation.

In the method and procedure for entering/releasing the CoMP operation mode and controlling a terminal to start/stop CoMP operation, the CoMP function may be supported by setting the CoMP operation mode and activating CoMP operation. That is, the CoMP operation mode may be set by setting a separate parameter before entering a CoMP operation period. For example, by setting a separate threshold value for entering or releasing the CoMP operation mode or an event condition for entering or releasing the CoMP operation mode, it is possible to set the CoMP operation mode through a RRC message, and to start or terminate CoMP operation through a MAC control message allowing dynamic, instantaneous control. In this case, the case where CoMP operation is stopped through a MAC control message means not the case where the CoMP operation mode is released but the case where CoMP operation is deactivated. The case where the CoMP operation mode has been set means that CoMP operation can again be activated through a MAC control message. Such setting/releasing of the CoMP operation mode and starting/stopping of CoMP operation can be controlled through separate timers, event settings or control messages.

In the heterogeneous network environment of the packet-based mobile communication system as described above, unlike a handover in which a serving cell changes according to movement of a terminal, a separate control procedure for CoMP operation in which a terminal transmits or receives packet information to or from a plurality of points through a macro layer base station(s), a base station(s), and a remote wireless node(s) is required.

Accordingly, a base station has to set measurement and report parameters in consideration of UE capability and the CoMP environments of neighboring nodes. A base station determines whether to perform CoMP operation with respect to a terminal that has established a connection to the base station, in consideration of radio channel information measured and reported by the terminal, radio channel information measured by the base station, call quality (packet error rate, the generation frequency of HARG, etc.), a ping-pong handover (HO) of the terminal, etc. The ping-pong handover is the case where an arbitrary terminal performs a handover while quickly moving between the service areas of several base stations or several cells (specifically, two cells), and reduces system performance by performing frequent signaling and an arbitrary access procedure.

Particularly, in order to avoid frequent occurrence of a ping-pong handover and improve system performance, it is possible to determine whether to perform a handover or whether to perform CoMP operation, in consideration of a serving cell ID (in the case of Carrier Aggregation (CA), a source Pcell), and stay time information in several handovers performed just before a handover performed by an arbitrary terminal. In order to reduce overhead due to control signaling, it is possible to determine whether to perform CoMP operation in consideration of only a serving cell ID (in the case of CA, a source Pcell) and a stay time in a final handover. For example, if a serving cell ID used in a final handover is the same as a target cell ID that will be used in a handover to be currently performed, and a stay time value is smaller than a threshold value for CoMP operation, it can be determined that CoMP operation, instead of a handover, has to be performed. Also, if the occurrence number of handovers is equal to or greater than a predetermined value for an arbitrary time period set by the base station, or if a point changes in a heterogeneous network environment, the base station may determine that CoMP operation has to be performed, and for this, the base station sets a counter parameter for counting handover operations or point changes or a timer value for setting a monitoring period, and notifies the corresponding terminal(s) through system information or a RRC control message.

Also, if a micro layer base station(s) or a remote wireless node(s) in the intra-eNB of FIG. 1 uses the same ID, it is possible to apply a separate point selection/association process instead of a general handover procedure when a terminal moves to the micro layer base station or the remote wireless node having the same cell ID. Accordingly, a primary base station determines whether to perform point selection or to perform CoMP operation using a stay time and a source point ID used in point selection finally performed.

Also, the system may apply a general handover procedure according to a cell change, without operating in the CoMP operation mode, in consideration of the load states of a macro layer base station and a local node (a micro layer base station or a remote wireless node) in the system, an interference environment, and the mobility speed of a terminal, although the system can support CoMP. For this, a separate event value or measurement reference value is set, and whether to perform a CoMP operation mode or to perform a handover may be determined through comparison with the separate event value or measurement reference value.

Method for Mobility Management in Consideration of Interference Between Cells, According to the Present Invention

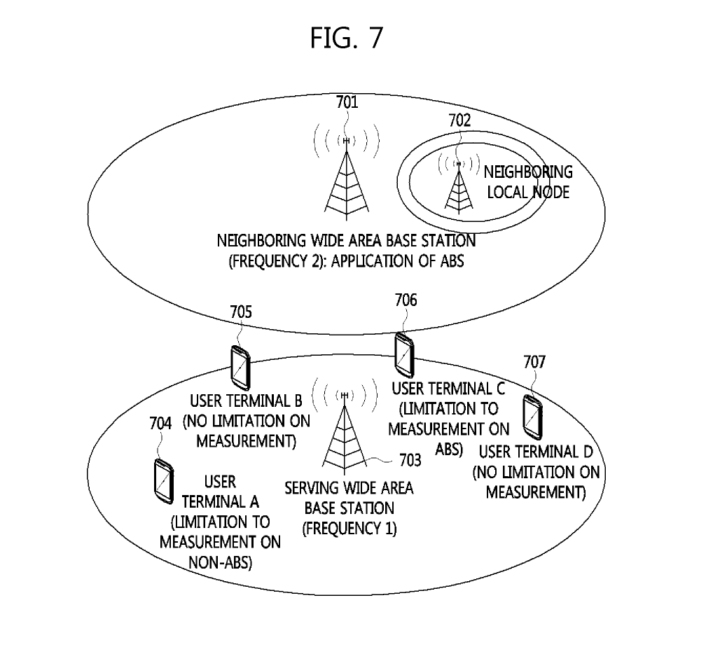

FIG. 7 is a view for explaining the concept of mobility management in consideration of interference between cells in a heterogeneous network environment, according to an embodiment of the present invention.

Referring to FIG. 7, a serving macro layer base station 703 provides service at a frequency 1, and may be a macro layer base station that operates local nodes in its service area or that have no local node in its service area.

Terminals UE A, UE B, UE C, or UE D that are in the service area of the serving macro layer base station 703 may allow a measurement gap to measure a neighboring macro layer base station 701 that provides service at a frequency 2 when the terminals have failed to find an appropriate base station that is to perform a handover at the frequency 1.

A measurement period represents a period in which no scheduling is performed for a predetermined time such that terminals that maintain a connection to a serving base station to receive service from the serving base station can search for and measure neighboring base stations that operate at different frequencies. Accordingly, the terminals UE A, UE B, UE C, and UE D search for and measure neighboring base stations for a measurement period decided by the serving base station 703. However, as illustrated in FIG. 7, in a HetNet environment where a neighboring macro layer base station 701 operates at a frequency that is different from that of the serving macro layer base station 703, together with a local node 702, the neighboring macro layer base station 701 and the local node 702 may perform interference control therebetween using ABS described above.

In this case, the terminal UE A, UE B, UEC, or UE D may differentiate radio resources of reception signals from neighboring macro layer base stations or local nodes to be measured, according to the location of the terminal.

When the neighboring macro layer base station 701 applies ABS, the terminal UE A 704 has to be controlled to measure a subframe or a radio resource area to which no ABS has been applied, transmitted from the neighboring macro layer base station 701. If measurement with respect to the neighboring macro layer base station 701 is performed in a subframe to which ABS has been applied or regardless of application of ABS, due to the influence of ABS, a reception signal from the neighboring macro layer base station 701 may be measured as a signal level that is worse than its actual signal level.

The terminal UE B 705 located close to the center of the neighboring macro layer base station 701 may perform measurement with respect to a reception signal from the neighboring macro layer base station 701, regardless of application of ABS.

The terminal UE C 706 is located at the edge area of the service areas of the neighboring macro layer base station 701 and the neighboring local node 702. The edge area is an area to which Cell Range Extension (CRE) is applied, and the edge area is controlled such that an offset value is applied to reception signals from terminals belonging to the edge area, so that the terminals are connected to the local node 702 rather than the macro layer base station (701?). Although no CRE is applied to the edge area, since strong interference signals are generated in the edge areas of the neighboring wide base station 701 and the local node 702, measurement on signals transmitted from the neighboring local node 702 is performed in the subframe or radio resource area to which an ABS pattern is applied by the neighboring macro layer station 701.

The terminal UE D 707 may perform, when it approaches the center of the neighboring local node 702, measurement on reception signals from the neighboring local node 702 regardless of application of ABS.

Generally, the serving macro layer base station 703 may estimate the locations of terminals in its own service area. For example, the serving macro layer base station 703 may estimate the locations of terminals using channel quality information (for example, Channel Quality Indication (CQI), Channel Status Indication (CSI), etc.) reported by the terminals. However, it is difficult for the serving macro layer base station 703 to, in advance, recognize information about the relative locations of terminals in its own service area with respect to the neighboring macro layer base station 701 or the neighboring local node 702.

That is, it is possible that the serving macro layer base station 703 estimates the locations of the terminals using the results of measurement on the neighboring base station or the neighboring local node, measured and reported by the terminals. Accordingly, the serving macro layer base station 703 notifies ID information of neighboring base stations, ABS pattern information, etc. to the terminals, while allowing a measurement period to the terminals for measurement with respect to neighboring base stations (macro layer base stations or local nodes) that operate at different frequencies. The base station ID information includes IDs for identifying base stations in a physical layer, IDs for uniquely identifying arbitrary base stations in the system, and group ID information of arbitrary base stations or nodes. For example, the base station ID information includes Physical Cell Identifiers (PCIs), Cell Global Identifiers (CGIs), Closed Subscriber Group (CSG) IDs, etc. which are used in the LTE system. The terminals that have received ABS pattern information and base station ID information may measure the neighboring base stations (macro layer base stations or local nodes) in the corresponding measurement period, perform measurement on radio resources to which ABS has been applied and measurement on radio resources to which no ABS has been applied, generate the results of measurement, and report the results of measurement to the base station. Based on the report from the terminals, the serving base station may estimate the relative locations of the terminals in the service area of the serving base station with respect to the neighboring base stations, and select a target base station to which the corresponding terminal will be handed over, thereby controlling the handover of the terminal.

The serving base station may decide a target base station to which the corresponding terminal will be handed over or determine that the terminal has to continues to receive service from the serving base station, by applying the methods described above with reference to FIGS. 5 and 6 to the results of measurement on the neighboring base stations (macro layer base stations or local nodes) in radio resources to which ABS has been applied and the results of measurement on the neighboring base stations (macro layer base stations or local nodes) in non-ABS radio resources to which no ABS has been applied, reported by the terminals, to acquire the difference reference values between the ABS measurement results and the non-ABS measurement results or threshold values (offset values) on the measurement results. Here, the threshold values may be differentiated according to application of ABS, the type (a macro layer base station, a local node, a CSG cell, or whether or not access to a CSL cell is allowed, a home base station) of the neighboring base station. Also, the threshold values may be differentiated according to terminals. Accordingly, the serving base station may compare the results measured and reported by the terminals to the threshold values to manage mobility management according to the results of the comparison, notify the threshold values, the reference values, etc. to the terminals, and control the terminals to selectively report the results of measurement. If the terminals selectively report, signal overload can be reduced.

Also, although only the results of measurement on the non-ABS radio resources are reported since the measurement period allowed by the serving base station is not aligned with the ABS pattern of the neighboring base station, the base station may estimate the results of measurement on non-ABS radio resources reported by the corresponding terminal, to determine whether the results of measurement have been over-estimated or under-estimated, by comparing the results of measurement reported by other terminals. Accordingly, the serving base station may align the ABS patterns of neighboring base stations as necessary to set measurement operation of the terminals. Accordingly, the serving base station may align the measurement period with the ABS pattern of the neighboring base station as necessary, to thereby set measurement operation of the terminal.

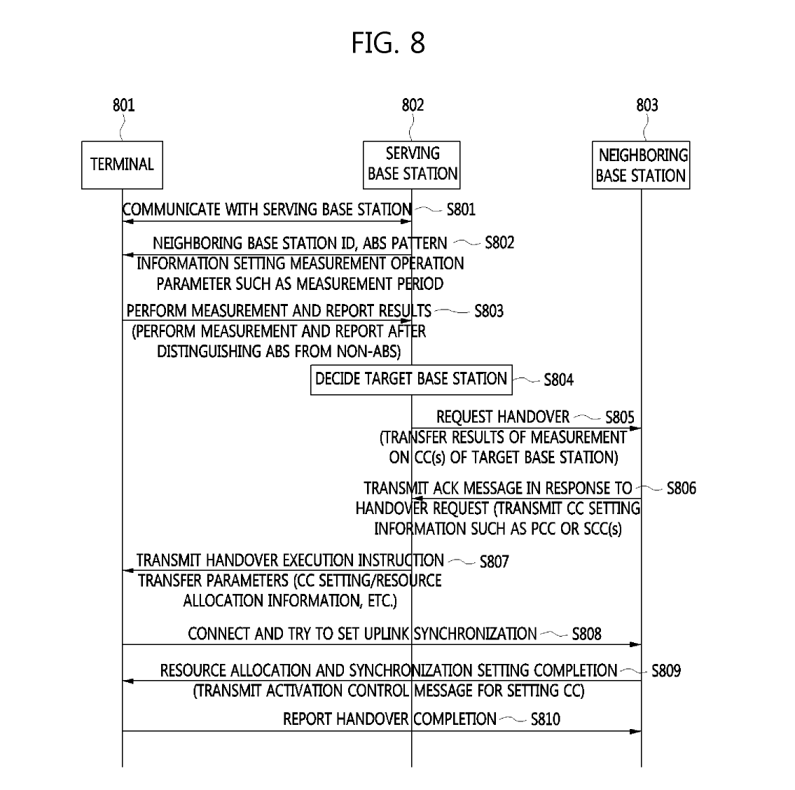

FIG. 8 is a flowchart illustrating a method of managing mobility in consideration of interference between cells in a heterogeneous network environment, according to an embodiment of the present invention.

Referring to FIG. 8, in order to perform mobility management and handover between frequencies in a HetNet environment, a serving base station 801 and a terminal 801 exchange information about UE capability with each other (S801) to determine whether a CoMP function is supported, and the serving base station 802 provides the terminal 801 with ABS pattern information, base station ID information, and measurement period setting information (S802). The terminal 801 performs measurement on radio resources (or subframes) to which ABS has been applied and measurement on radio resources (or subframes) to which no ABS has been applied, respectively, with respect to measurement on neighboring base stations (macro layer base stations or local nodes) operating at different frequencies, and reports the results of the measurements after distinguishing the results of the measurements (S803).

The serving base station 802 determines whether to perform a handover and decide a target base station based on the report from the terminal 801 (S804), and transmits a handover execution request to a neighboring base station 803 that is a target base station (S805). Thereafter, the neighboring base station 803 transmits an ACK message in response to the handover execution request (S806), and the serving base station 802 transmits a handover execution instruction to the terminal 801 (S807). Operations 5804 through 5810 correspond to a general handover procedure, and accordingly, detailed descriptions therefor will be omitted.

For operation 5802, the serving base station 802 may use a method of configuring a control message for setting measurement operation using a ABS pattern and base station ID information, together with measurement period setting information, and transmitting the control message to the terminal 801, a method of configuring an ABS pattern and base station ID information as a separate control message and transmitting the control message to the terminal 801, and a method of transmitting system information to all terminals belonging to the service area of the base station 802, etc. The control message may be set using a layer 3 RRC control message or a layer 2 MAC control message, as described above.

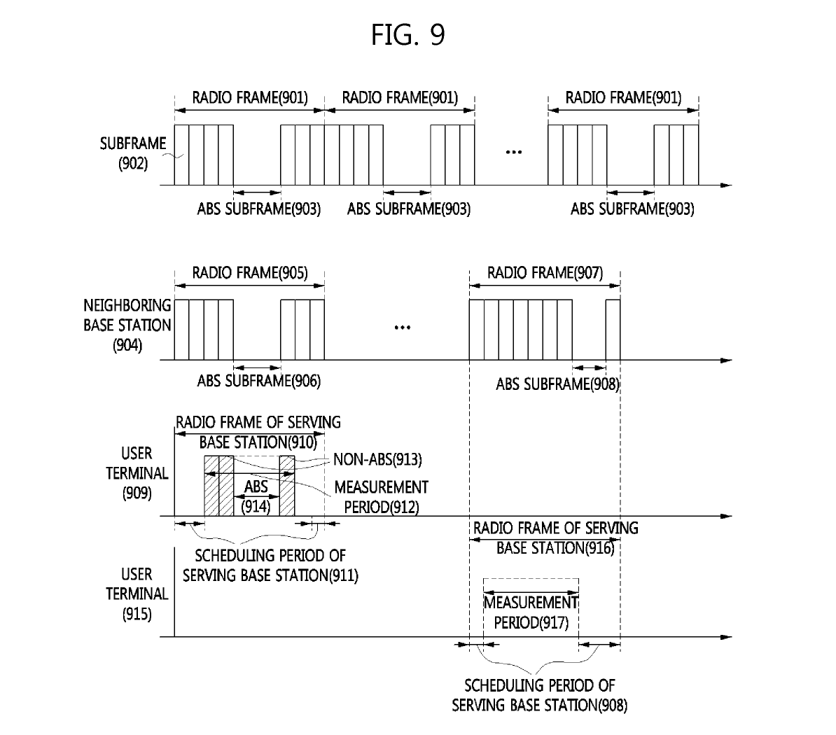

FIG. 9 is a conceptual view for explaining an example where an ABS pattern is applied and a measurement period is set in a heterogeneous network environment, according to an embodiment of the present invention.

Referring to FIG. 9, each radio frame 901 consists of a plurality of subframes 902 each corresponding to a transmission period or a scheduling period. In the heterogeneous network environment, an ABS subframe 903 as described above may be set in order to avoid interference. The ABS subframe 903 may be repeated per a predetermined period, and may be set to have the same location (corresponding to a subframe index in the corresponding radio frame 901) and the same period (corresponding to the number of subframes to which ABS has been applied), or to have different locations and different periods for each radio frame. The ABS subframe 903 may be applied for a macro layer base station or a local node, according to the state of interference or the type of a base station, as described above. Accordingly, in a HetNet environment where an arbitrary macro layer base station and a local node are configured at the same frequency, as described above with reference to FIGS. 4 and 5, a method and procedure for application of an ABS pattern and interference controlling may be applied. Also, a neighboring base station 904 that operates at a different frequency exists near UE 909 and UE 915 located in the service area of an arbitrary serving base station, and if the patterns of ABS subframes 906 and 908 are applied to the neighboring base station 904, the serving base station may set a measurement period 912 in a radio frame 910 of the serving base station with respect to the UE 909, as described above with reference to FIG. 6.

Accordingly, the UE 909 receives service from the serving base station in a period 911 in which the serving base station schedules the corresponding terminal, and performs measurement on the neighboring base station operating at the different frequency in the measurement period 912. This case corresponds to the case where the ABS subframe of the neighboring base station 904 is aligned with the measurement period 912 for the UE 909, and the measurement period 912 includes a period 914 in which ABS has been applied and a period 913 in which no ABS has been applied. Accordingly, according to the measurement operation setting method and procedure as described above with reference to FIGS. 7 and 8, the terminal performs measurement on the subframe 914 in which ABS has been applied and measurement on the non-ABS subframe 913 in which no ABS has been applied, respectively, with respect to signals from the neighboring base station 904, and report the results of the measurements after distinguishing them. Unlike this, in the case of the UE 915, a measurement period 917 in a radio frame 916 set by a serving base station is not aligned with an ABS subframe 908 of a radio frame 907 of a neighboring base station. Accordingly, in the case of the UE 915, all measurement periods correspond to non-ABS subframes in which no ABS has been applied, and the UE 915 reports only measurement results on the non-ABS subframes to the serving base station. The serving base station may set a measurement period such that the measurement period is always aligned with an ABS subframe of a neighboring base station operating at a different frequency. Unlike this, the base station may set a measurement period such that the measurement period is aligned with an ABS subframe of a neighboring base station operation at a different frequency when the base station determines that the measurement period needs to be aligned with the ABS subframe or when the base station receives the corresponding request from a terminal. If there is no limitation on alignment between a measurement period set by the serving base station and an ABS subframe of the neighboring base station, the base station may set a measurement period for each terminal without considering alignment between the measurement period and the ABS subframe of the neighboring base station.

If the neighboring base station uses the same frequency as that used by the serving base station, the measurement method as described above with reference to FIGS. 4 and 5 may be used.

While the example embodiments of the present invention and their advantages have been described in detail, it should be understood that various changes, substitutions and alterations may be made herein without departing from the scope of the invention.

What is claimed is:

1. An operation method of a terminal which receives service from a first base station and a second base station, the method comprising:
receiving connection control signaling information for the second base station from the first base station; and
performing connection control on the second base station based on the connection control signaling information.

2. The operation method of claim 1, wherein the first base station is a macro layer base station which is a primary base station.

3. The operation method of claim 1, wherein the second base station is one of a micro layer base station, a remote wireless transmission node, a femto cell base station, a closed subscriber group (CSG) cell base station.

4. The operation method of claim 1, wherein the connection control signaling information includes information for at least one of establishing, maintaining of connection, and changing a connection of a radio bearer for data transmission or a signaling radio bearer for transmitting a radio bearer, control of measurement, resource allocation and scheduling, and connection control for a radio bearer.

5. The operation method of claim 4, wherein the information for the resource allocation and scheduling includes at least one of radio control channel information, subcarriers setting, transmission sub-frame information, setting of physical layer control parameters, and configuring feedback information.

6. The operation method of claim 1, further comprising transmitting or receiving packet information through the first base station and the second base station.

7. An operation method of a first base station and a second base station which provide service for a terminal, the method comprising:
transmitting, by the first base station, connection control information for the second base station to the terminal; and
connection control being performed for the second base station through a control of the terminal based on the connection control information.

8. The operation method of claim 7, wherein the first base station is a macro layer base station which is a primary base station.

9. The operation method of claim 8, wherein the second base station is one of a micro layer base station, a remote wireless transmission node, a femto cell base station, a closed subscriber group (CSG) cell base station.

10. The operation method of claim 8, wherein the connection control signaling information includes information for at least one of establishing, maintaining of connection, and changing a connection of a radio bearer for data transmission or a signaling radio bearer for transmitting a radio bearer, control of measurement, resource allocation and scheduling, and connection control for a radio bearer.

11. The operation method of claim 10, wherein the information for the resource allocation and scheduling includes at least one of radio control channel information, subcarrier configuration information, transmission sub-frame information, configuration information of physical layer control parameters, and feedback configuration information.

12. The operation method of claim 8, further comprising transmitting packet information to the terminal or receiving packet information from the terminal through the first base station and the second base station.
